(19) United States
(12) Patent Application Publication
(10) Pub. No.: US 2020/0120914 A1
(43) Pub. Date: Apr. 23, 2020

(54) Bait Container

(71) Applicant: Angling Innovations, LLC, Maple Plain, MN (US)

(72) Inventor: Gary Gniffke, Maple Plain, MN (US)

(21) Appl. No.: 15/675,964

(22) Filed: Aug. 14, 2017

(51) Int. Cl. A01K 97/05; A01K 97/01; A01K 97/20

(52) U.S. Cl. CPC A01K 97/05; A01K 97/04; A01K 97/20; A01K 97/01

(57) ABSTRACT

A bait container is described that includes a thermal transfer chamber that is capable of cooling or heating water and bait within the container. The bait container is further capable of separating bait from the water to allow access to the bait in a more efficient manner. The bait container is also easily disassembled to allow complete cleaning of the container and its component parts.

### CROSS-REFERENCE TO RELATED APPLICATIONS

Not Applicable

### FEDERAL SPONSORSHIP

Not Applicable

### JOINT RESEARCH AGREEMENT

Not Applicable

### TECHNICAL FIELD

This invention pertains generally to bait fishing containers. More particularly, the invention pertains to a bait container capable of cooling water and bait within the container. The bait container in accordance with the invention is further capable of separating the bait from the water to allow access to the bait in a more efficient and enjoyable manner for the angler. The bait container of the invention is also easily disassembled to allow complete cleaning of the container and its component parts.

### BACKGROUND

Generally, anglers have used various containers, including buckets and pails, for transporting and storing live fishing bait. Often times it is desirable to store the bait in a container for multiple days. During hot or cold outdoor temperature extremes, the temperature of the water within a pail or bucket tends to equalize with the ambient temperature, which may affect the freshness of the bait within the container. Over the years, various containers have been modified in an attempt to keep the bait fresh for longer periods of time. By way of example, a common minnow bucket may include multiple holes in the sides of the bucket to allow submersion of the container within a lake to allow the exchange of lake water into the bucket. When submersing the container in the lake, the lake water is preferably cooler than the temperature of the water within the bucket. The lake water, however, may not be at an ideal or preferred temperature to keep the bait fresh.

In the past, a minnow net has been used to scoop bait out of a bucket. In order to scoop minnows from a bucket it may be necessary to swirl the net within the bucket, however a swirling motion of the net within the bucket tends to agitate the bait making it even more difficult to scoop the bait. A need exists for an efficient system for extracting bait from a bucket. It is desirable to provide a bait container with the ability to either increase or decrease the temperature of the water within the bait container relative to the ambient temperature of the bucket. Further, it is desirable to provide an efficient system for extracting bait from the bait container. Also, at times, it may be preferred to control the temperature of the water within the bait container while at the same time providing an efficient system to remove bait from the container.

### SUMMARY

Embodiments according to aspects of the invention provide a bait container that is rigid, durable and capable of cooling or warming the water within the bait container. According to other aspects, the bait container of the invention includes a system to remove bait from the water within the container without entirely removing the bait from the container. The invention may include a primary and secondary lid to contain the bait within the container while providing an access opening to the bait within the container.

These and other embodiments according to aspects of the invention include an apparatus for containing fishing bait, wherein the apparatus includes an insulated receptacle, a bait strainer, a thermal transfer chamber, and a lid. The insulated receptacle has interior and exterior sides, an open top and an enclosed bottom. A space between the interior and exterior sides may be filled with an insulator to increase the insulating properties of the receptacle. By way of example and without limitation intended the space may be filled with a polyurethane. In accordance with aspects of the invention the receptacle may comprise a removable inner liner and rigid outer shell. A space between the inner liner and outer shell may be filled with air to provide an insulating property to the receptacle. The insulated receptacle may further include retaining hooks that engage an underside of the lid to thereby engage the lid to the receptacle.

The bait strainer is contained within the insulated receptacle wherein the bait strainer has sides extending upward from a bottom sieve. The bait strainer is sized such that the sides are proximate with corresponding interior sides of the insulated receptacle. The thermal transfer chamber is attached to and extends from the bait strainer wherein a free end of the chamber forms a handle for the bait strainer. The thermal transfer chamber is submersed in fluid contained within the receptacle. The chamber may be filled with a hot or cold media to thereby transfer a heat or cooling to the fluid within the receptacle. The lid is coupled to the open top of the insulated receptacle and retains bait within the receptacle. The lid further helps maintain the temperature within the receptacle.

According to aspects of the invention the lid may include a hinged cover coupled to an opening formed in the lid. The cover provides access to bait contained within the receptacle without removing the entire lid. Also, the handle end of the bait strainer may be pulled up through the opening in the lid to elevate the bait above the fluid within the receptacle. In this manner an angler may remove bait from the container without having to chase and catch the bait swimming within the fluid. Additionally, the heat transfer chamber may be attached to the bait strainer proximate a center of the bottom sieve, thereby effectively centering the heat transfer chamber within the center of the receptacle. The heat transfer chamber may more particularly a central hollow column and a removable plug that forms a handle at a top, free end of the central column. Additionally, a handle may attach to the exterior sides of the insulated receptacle to provide an efficient mechanism to carry the bait container. Also, the lid may include a grip member that extends from the lid. The grip may facilitate removal of the lid from the receptacle. Similarly, the cover may include a lip extending outward from an outer edge of the cover to facilitate opening of the cover from the lid.

Another embodiment according to aspects of the invention includes a bait container having an insulated receptacle, a bait strainer, a cooling chamber, a lid, and a cover. The insulated receptacle has interior and exterior sides, an open top and an enclosed bottom. The bait strainer has sides extending upward from a bottom sieve, wherein the bait strainer is sized such that the sides are proximate with corresponding interior sides of the insulated receptacle. The cooling chamber extends from the bait strainer and includes a central column having a fixed end attached to the bait strainer and a removable handle attached to a free end of the central column. The removable handle forms a plug at a top of the cooling chamber to retain coolant within the cooling chamber. The lid is coupled to the open top of the insulated receptacle and a hinged cover couples to an opening formed in the lid. The receptacle may be further comprised of an inner liner and outer shell. Also, the insulated receptacle may include retaining hooks that engage an underside of the lid to lock in place the lid to the receptacle.

The accompanying drawings, which are incorporated in and constitute a portion of this specification, illustrate embodiments of the invention and, together with the detailed description, serve to further explain the invention. The embodiments illustrated herein are presently preferred; however, it should be understood, that the invention is not limited to the precise arrangements and instrumentalities shown. For a fuller understanding of the nature and advantages of the invention, reference should be made to the detailed description in conjunction with the accompanying drawings.

### DESCRIPTION OF THE DRAWINGS

In the various figures, which are not necessarily drawn to scale, like numerals throughout the figures identify substantially similar components.

FIG. 1 is a front left upper perspective view of a bait container apparatus of the present invention shown with the access cover in a closed position;

FIG. 2 is a back right upper perspective view of a bait container apparatus of the type shown in FIG. 1;

FIG. 3 is a front left bottom perspective view of a bait container apparatus of the present invention;

FIG. 4 is a front left upper perspective view of a bait container apparatus of the present invention shown with the cover and strainer partially elevated above the bait receptacle and shown with the lid in an open position;

FIG. 5 is a front left bottom perspective view of the bait container of the type shown in FIG. 4;

FIG. 6 is a front perspective view of an embodiment of a strainer of the bait container apparatus of the present invention;

FIG. 7 is a front left upper perspective view of an embodiment of a cover and lid of the bait container apparatus of the present invention shown with the lid in an open position;

FIG. 8 is a back left bottom perspective view of an embodiment of a cover and lid of the bait container apparatus of the present invention shown in an open position;

FIG. 9 is a front left upper perspective view of an embodiment of the receptacle with a liner partially elevated above the receptacle of the bait container apparatus of the present invention;

FIG. 10 is a front left bottom perspective view of an embodiment of the receptacle with a liner elevated above the receptacle of the bait container apparatus of the present invention;

FIG. 11 is a front right upper perspective view of an embodiment of a receptacle of the bait container apparatus of the present invention;

FIG. 12 is a back left upper perspective view of an embodiment of a receptacle of the bait container apparatus of the present invention shown with the liner removed;

FIG. 13 is a back left upper perspective view of an embodiment of a liner of the receptacle of the bait container apparatus of the present invention;

FIG. 14 is a back left bottom perspective view of the liner of the receptacle of the type shown in FIG. 13;

FIG. 15 is a front upper perspective view of an embodiment of the strainer of the bait container apparatus of the present invention;

FIG. 16 is a front perspective view of an embodiment of the strainer of the bait container apparatus of the present invention shown with the handle removed;

FIG. 17 is a front left upper perspective view of a bait container apparatus of the present invention shown in an open position;

FIG. 18 is a back right upper perspective view of a bait container apparatus of the present invention shown in an open position;

FIG. 19 is a front perspective view of an embodiment of the bait container apparatus of the present invention shown in an open position and with the strainer in an elevated position; and

FIG. 20 is a front upper perspective view of an embodiment of the bait container apparatus of the present invention shown in an open position and with the strainer in an elevated position.

### DETAILED DESCRIPTION

The following description provides detail of various embodiments of the invention, one or more examples of which are set forth below. Each of these embodiments are provided by way of explanation of the invention, and not intended to be a limitation of the invention. Further, those skilled in the art will appreciate that various modifications and variations may be made in the present invention without departing from the scope or spirit of the invention. By way of example, those skilled in the art will recognize that features illustrated or described as part of one embodiment, may be used in another embodiment to yield a still further embodiment. Thus, it is intended that the present invention also cover such modifications and variations that come within the scope of the appended claims and their equivalents.

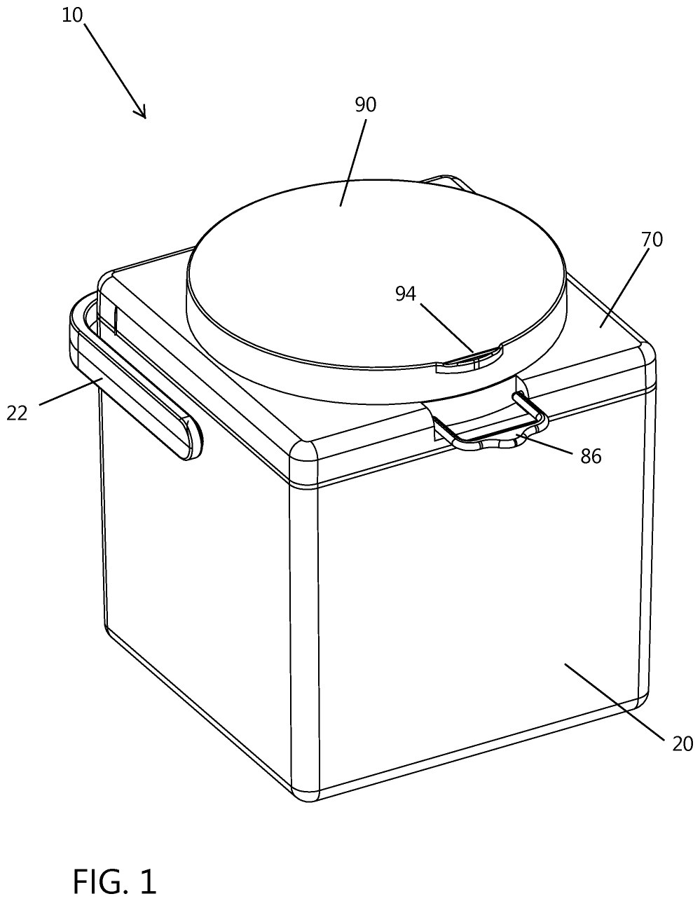

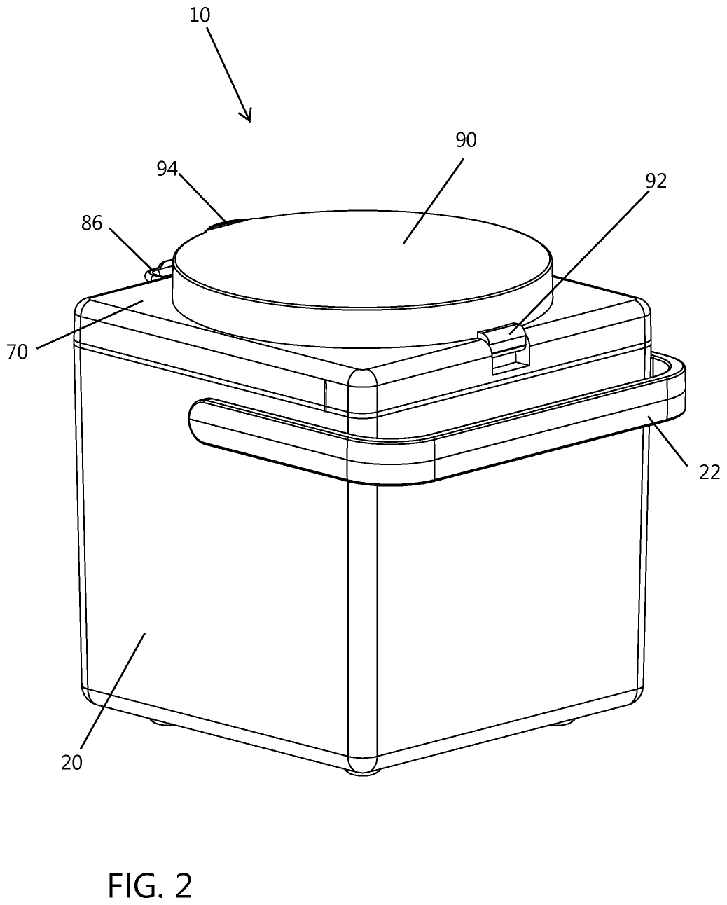

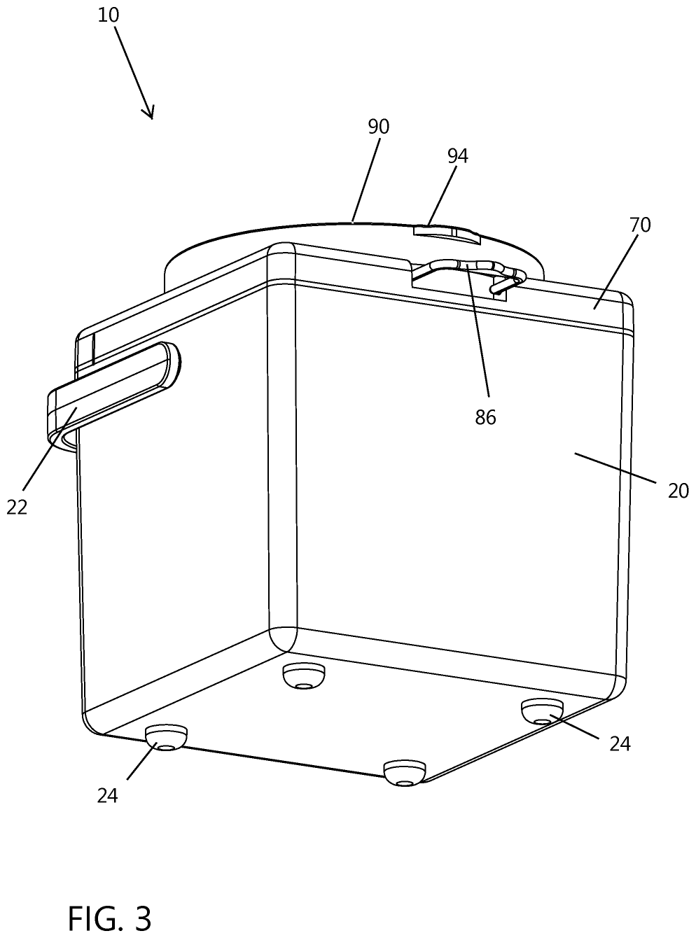

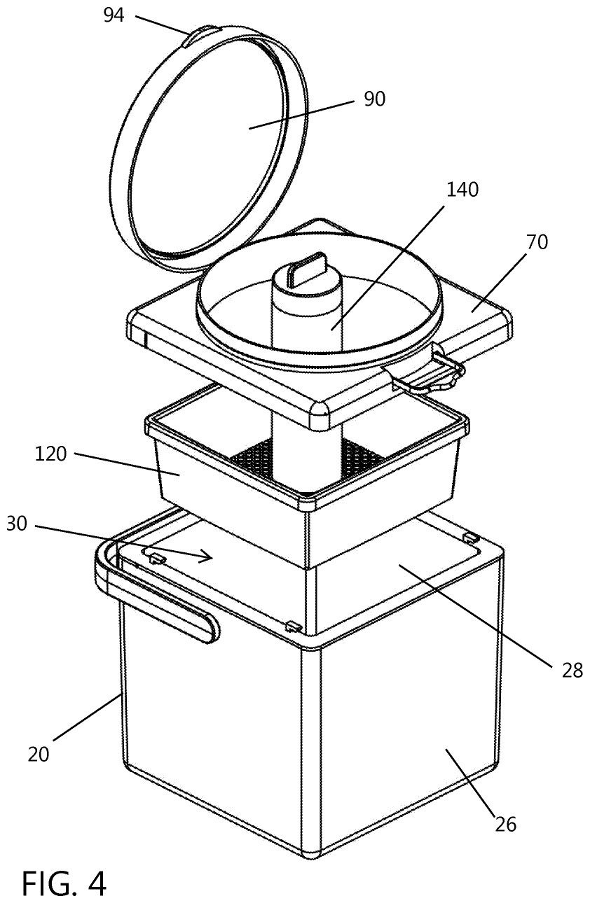

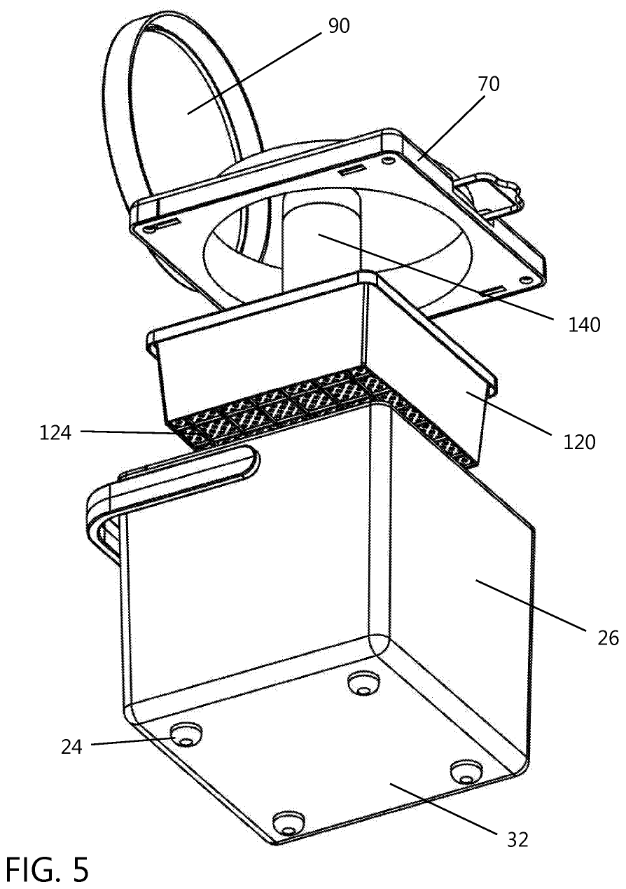

The bait container apparatus 10 of the present invention is particularly well suited for controlling the temperature of a liquid media in which live bait is kept within the container. The present invention is further particularly well suited to separate the bait from the liquid media when an angler seeks to remove a single bait from the container. With reference to the Figures, various embodiments according to aspects of the invention will be described in greater detail. With reference to FIGS. 1-3, a bait container assembly is shown in the fully assembled and closed mode and with reference to FIGS. 4-5 the bait container is shown with component parts disassembled.

The bait container 10 generally includes a container, bucket or receptacle 20, a lid 70, strainer 120, and thermal transfer chamber 140. The receptacle 20 generally includes a handle 22 that is attached to external sidewalls 26 of the container and may rotate between a stowed position (illustrated in the figures) and a carrying position. Bumpers 24 are fastened to the enclosed bottom 32 of the receptacle 20 to elevate the receptacle slightly off a ground surface. The lid 70 generally includes a handle 86 and cover 90. The cover 90 is attached to a base of the lid with a hinge 92. Cover 90 includes a tab 94 that may be used to lift the cover 90 off the base of the lid 90 to an open position. Handle 86 may be utilized to hold the lid 70 and receptacle 20 in place while the cover 90 is rotated open. As illustrated in FIGS. 4 and 5 the lid 70 and strainer 120 may be removed from an open top 30 of the receptacle 20. It may be desirable to remove the lid 70 and strainer 120 so that the component parts of the bait container 20 may be adequately cleaned. Those skilled in the art will also appreciate that the length and width of the perimeter of the strainer is sized only slightly smaller than the interior sidewall 28 of the container 20. In this manner, as the strainer is removed from the container, bait contained therein will remain confined within the strainer rather than slipping over the sides of the strainer into the receptacle 20.

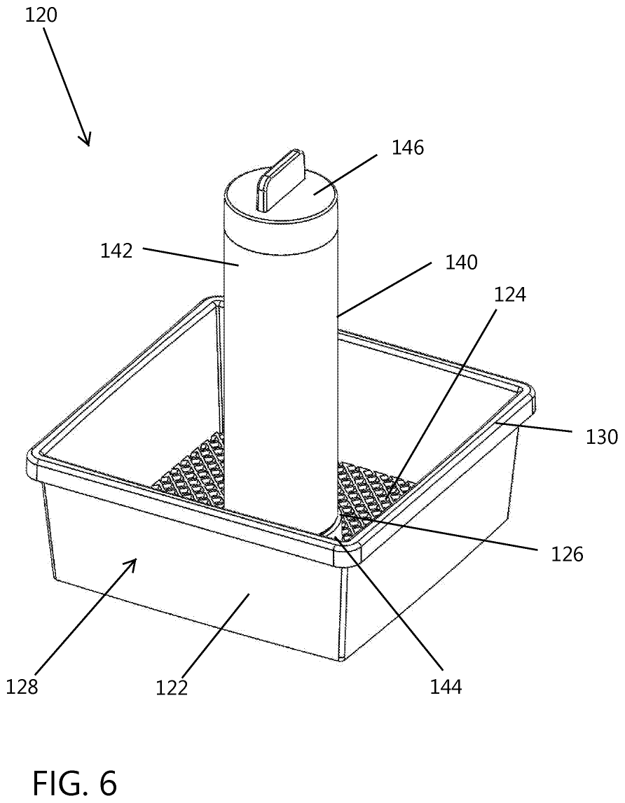

With referring to FIG. 6, the strainer 120 generally includes a bottom sieve 124 and sidewalls 122 extending from the bottom sieve. The bottom sieve 124 and sidewalls 122 together form a tray 128 in which bait may be contained. An upper ledge 130 extends outward and downward from an upper portion of the sidewall 122. The ledge 130 aligns proximate an interior sidewall 28 of the receptacle 20. In accordance with aspects of the invention, the ledge 130 may be made from a compressible rubber and sized slightly largely than the inner sidewall 28 such that as the strainer 120 is moved between the stowed position 134 and the elevated position 136 the ledge 130 remains in slight contact with the interior sidewall 28 of the receptacle. In this manner the ledge 130 prevents bait from flowing between the ledge 130 and inner sidewall 28. The thermal transfer chamber 140 is attached to the bottom sieve 124 proximate a center 126 of the sieve. The thermal transfer chamber 140 includes a hollow cylindrical column 142 attached to the sieve 124. The bottom or base 144 of the cylindrical column is enclosed such that a heating element or coolant may be contained within the hollow cylindrical column 142. A plug 146 encloses an open top end 148 of the thermal transfer chamber 142.

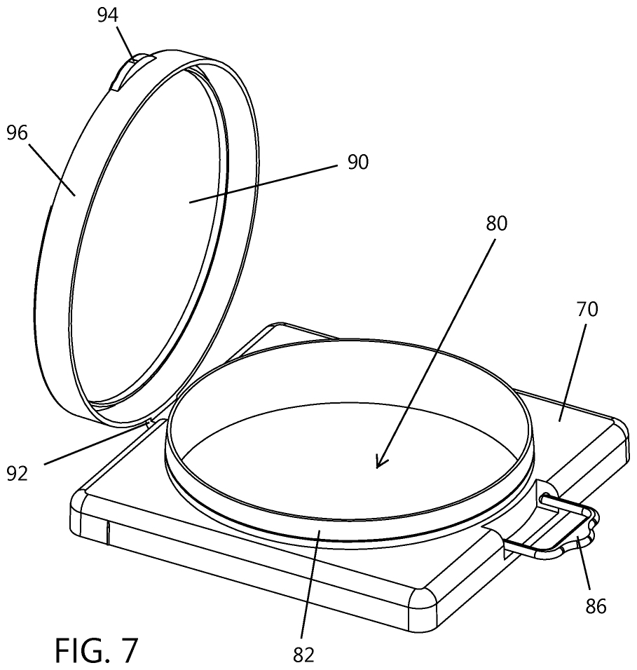

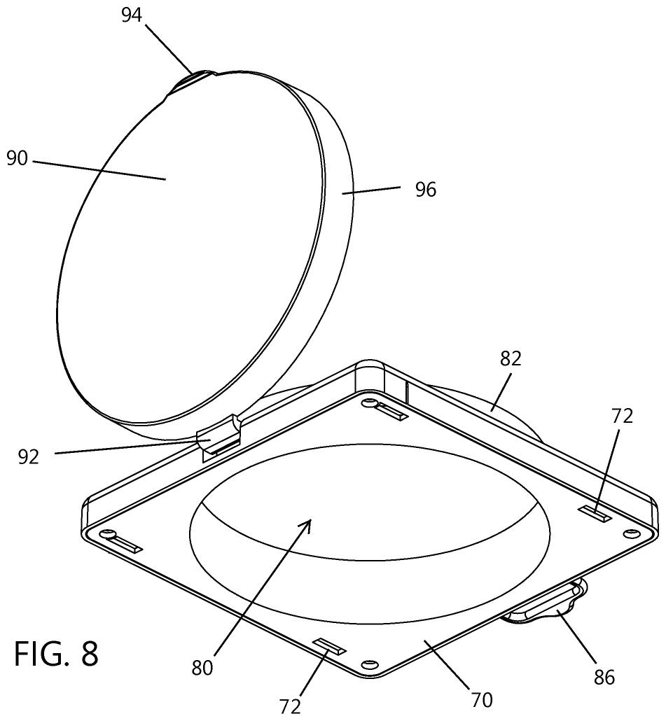

Referring to FIGS. 7 and 8 features of the lid 70 are illustrated in greater detail. The lid 70 generally includes a central opening 80 with a rim 82 extending upward from a base of the lid 70 and encompassing the opening 80. Cover 90 includes an outer edge or flange 96 that is sized to snuggly fit over the rim 82 of the lid 70. In this manner the cover 90 may be closed to help maintain the temperature within the container 10 for a longer period of time than it would if the cover were left in the open position. Slots 72 are formed in a bottom of a base of the lid 70 and are adapted to receive and engage with hooks 54 extending from an upper edge of the receptacle 20. The hooks 54 interlock in the slots to retain the lid 70 against an upper edge or flange 52 defining the open top 30 of the receptacle 20.

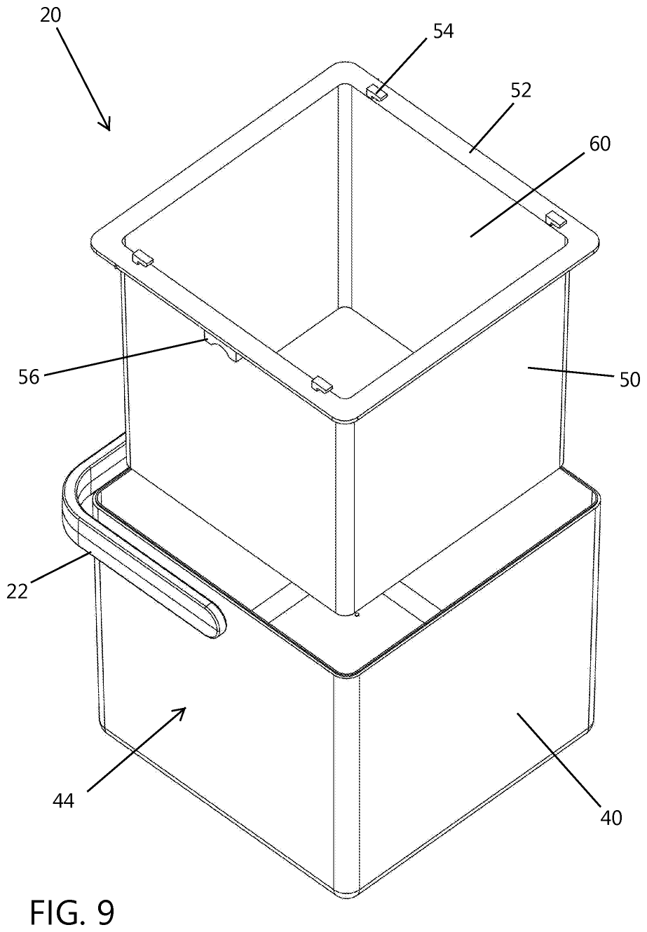

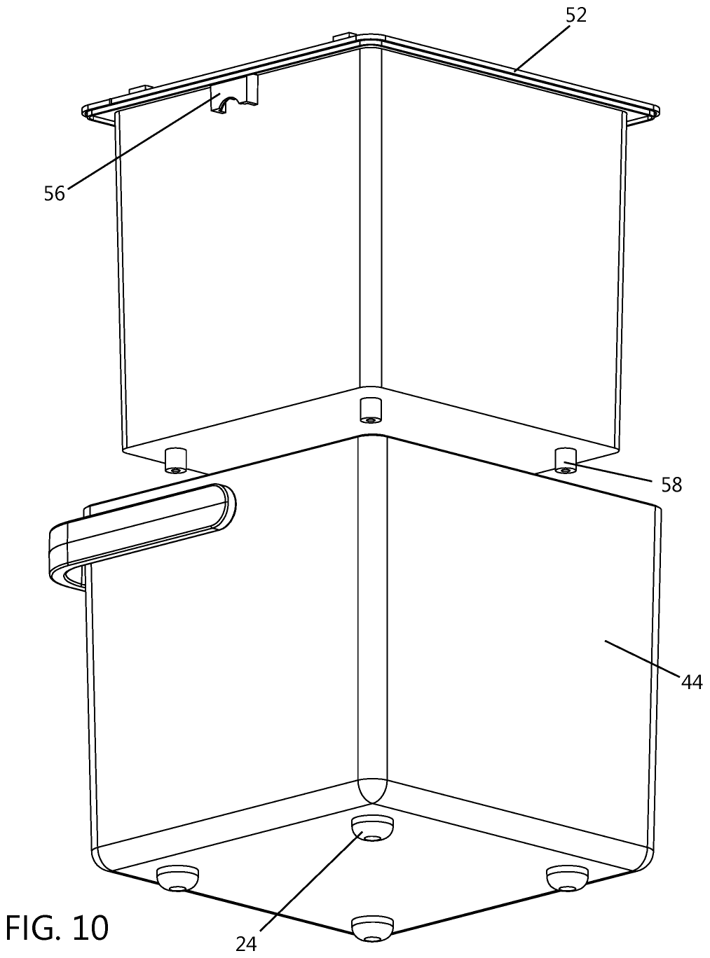

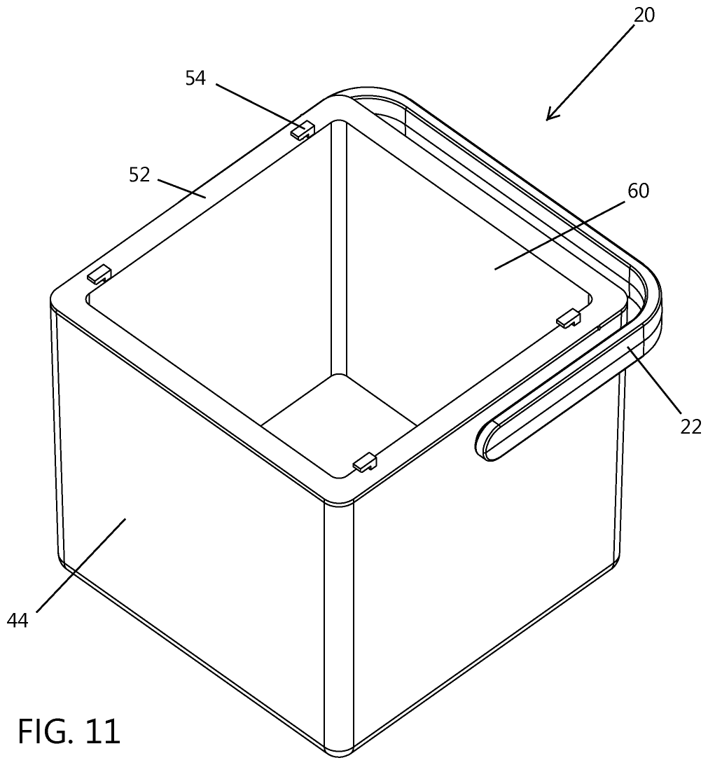

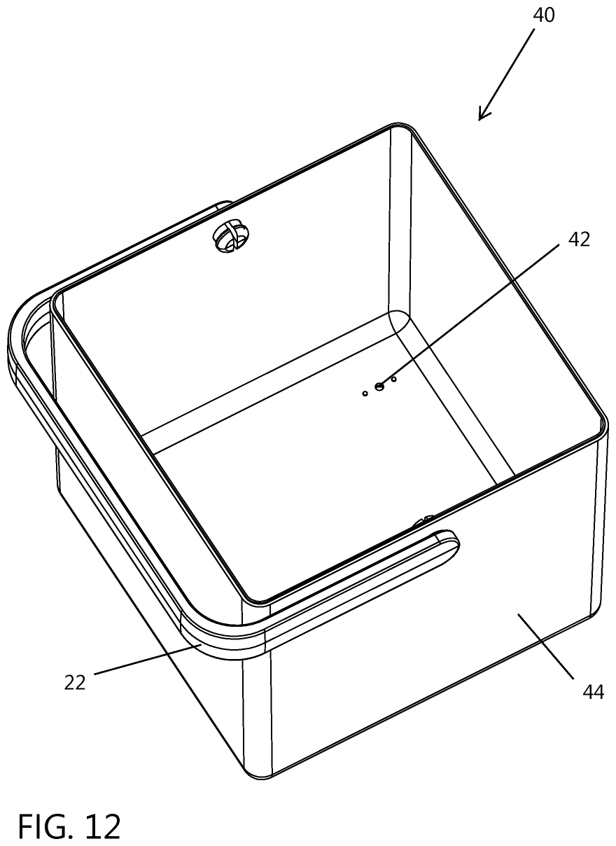

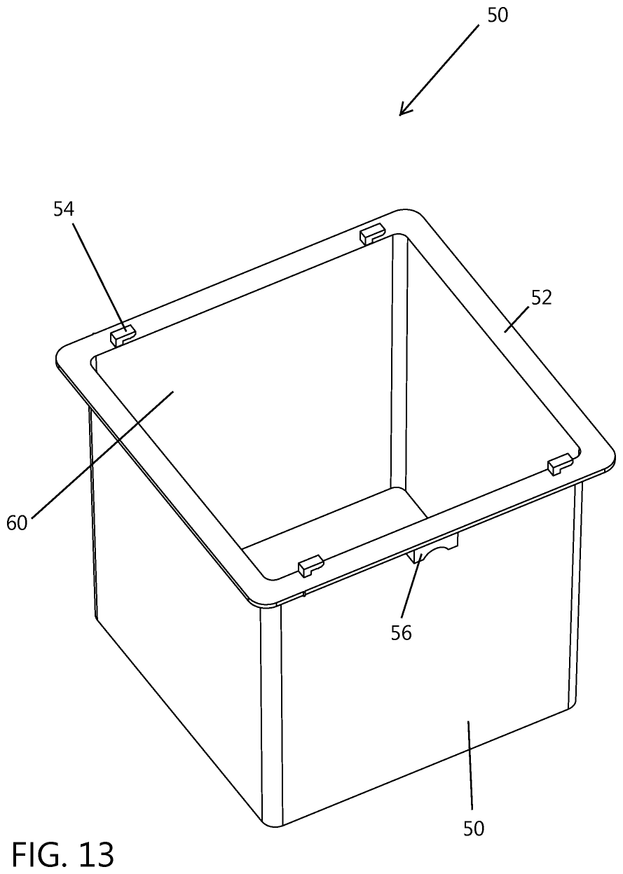

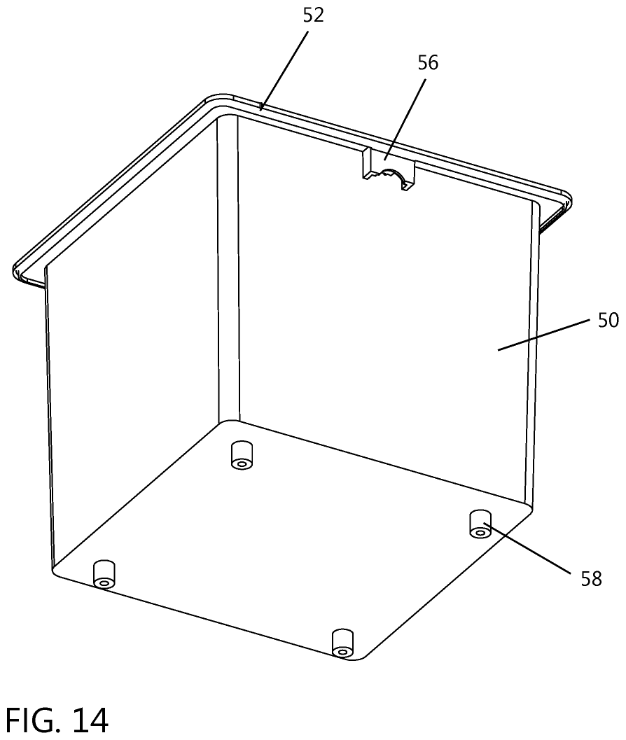

Referring to FIGS. 9 through 14 features of the receptacle 20 are illustrated in greater detail. Without limitation intended, the receptacle 20 may comprise an outer shell 40 and inner liner 50. An outer side of the shell 44 may define the exterior sidewall of the receptacle, while an interior sidewall of the inner liner may define the interior sidewall 28 of the receptacle 20. Apertures 42 extend through a bottom of the outer shell and are aligned such that the bumpers 24 may be attached or secured to the spacers 58 extending from a bottom of the inner liner 50. Handle supports 56 are formed on an upper flange 52 of the inner liner 50. The handle supports engage an end portion of the handles and provide additional structural integrity and support when the handle 22 is used to carry the bait container 10. A space between the outer shell 40 and inner liner 50 may be filled with air or an insulating material to increase the insulating properties of the receptacle. By way of example and without limitation intended the space may be filled with a polyurethane foam that adheres to the outer shell and allows separation of the inner liner and outer shell.

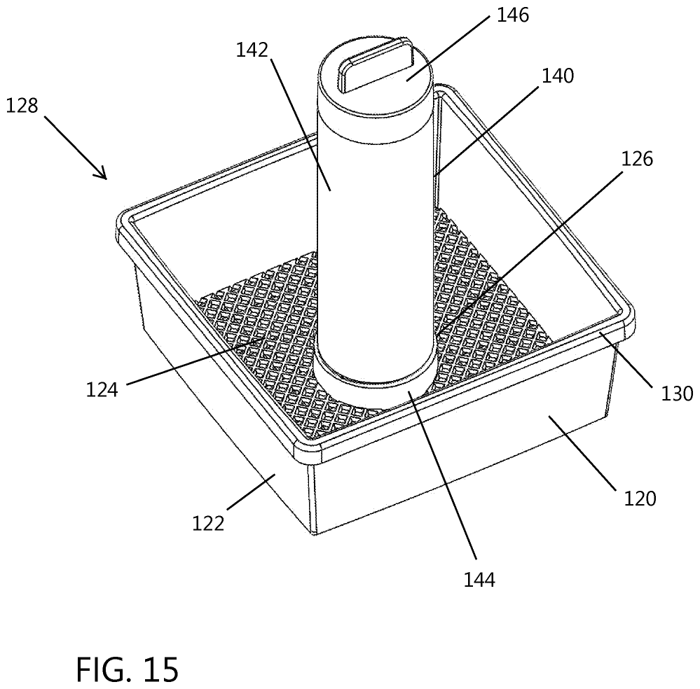

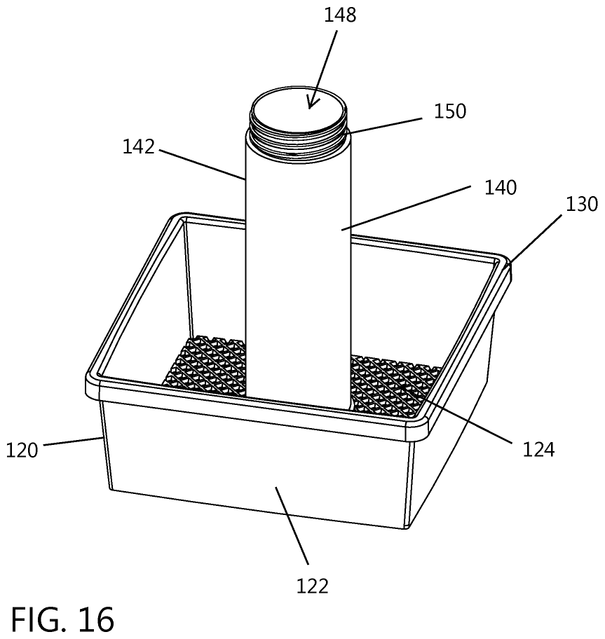

Referring to FIGS. 15 and 16 features of the strainer 120 are illustrated in greater detail. The strainer 120 generally includes a bottom sieve 124 that may be a wire screen or meshwork of fibers that allows liquids to flow through with little resistance while trapping bait against the bottom sieve 124. The bottom sieve 124 and sidewalls 122 together form a tray 128 in which bait may be contained. The height of the sidewall may be varied dependent upon the amount of bait to be contained within the bait container and the amount the strainer must be elevated within the container to rise above the water level within the receptacle. The thermal transfer chamber 140 includes a hollow cylindrical column 142 having a threaded free end 150 onto which plug 146 may be engaged. The thermal transfer chamber 142 may contain ice or hot water, for example, within the hollow cylinder. When the chamber 142 is submerged in water within the receptacle 20, the cooling or heating affect from the chamber transfers to the water until an equilibrium temperature is reached. In this manner, ice may be used to keep the bait container water cool during hot summer days and hot water may be used to warm the bait container water and avoid freeze ups during cold winter ice fishing.

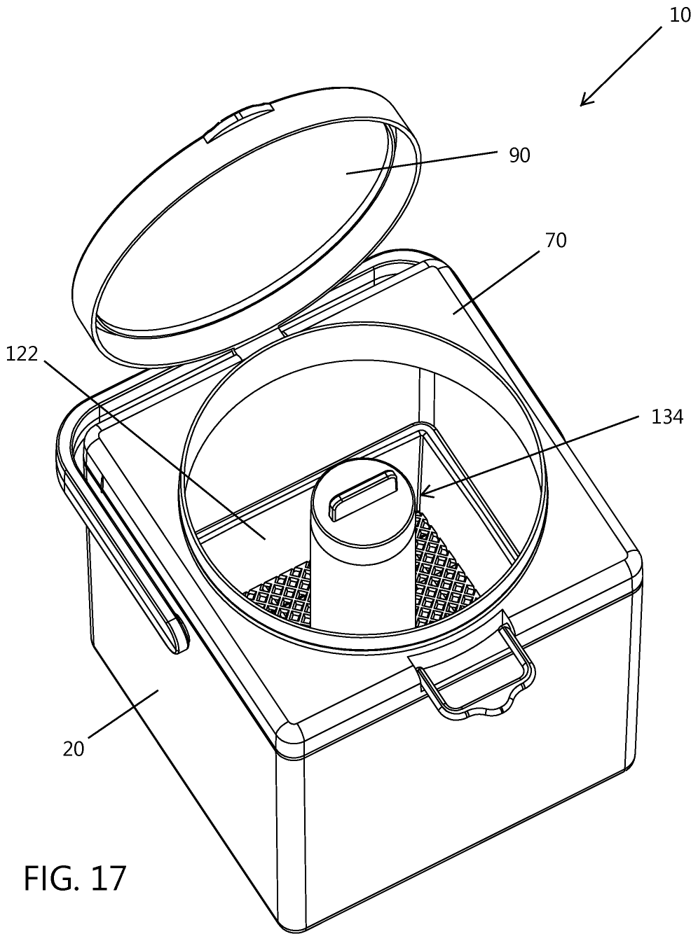

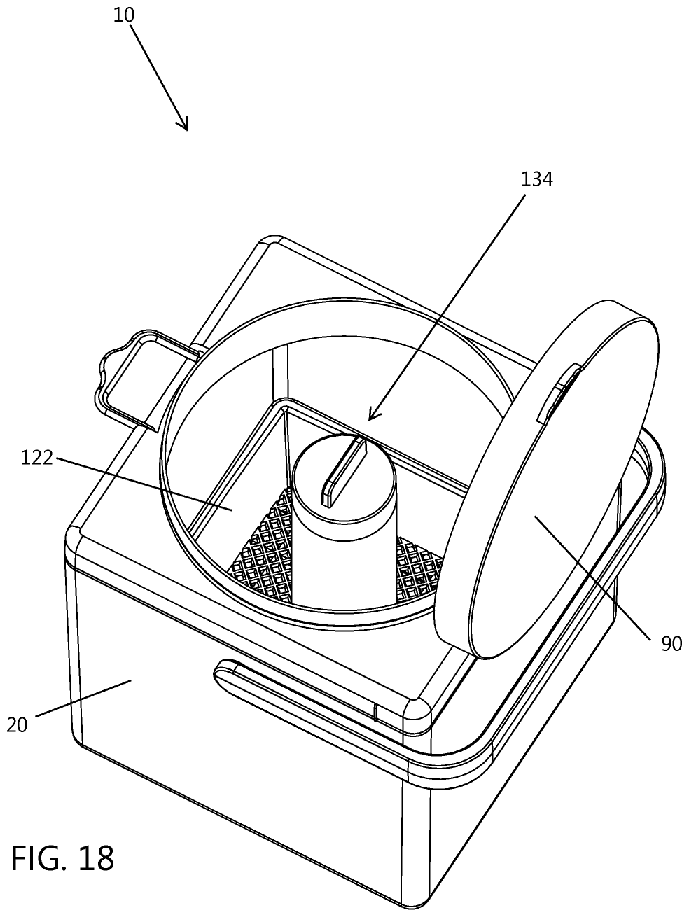

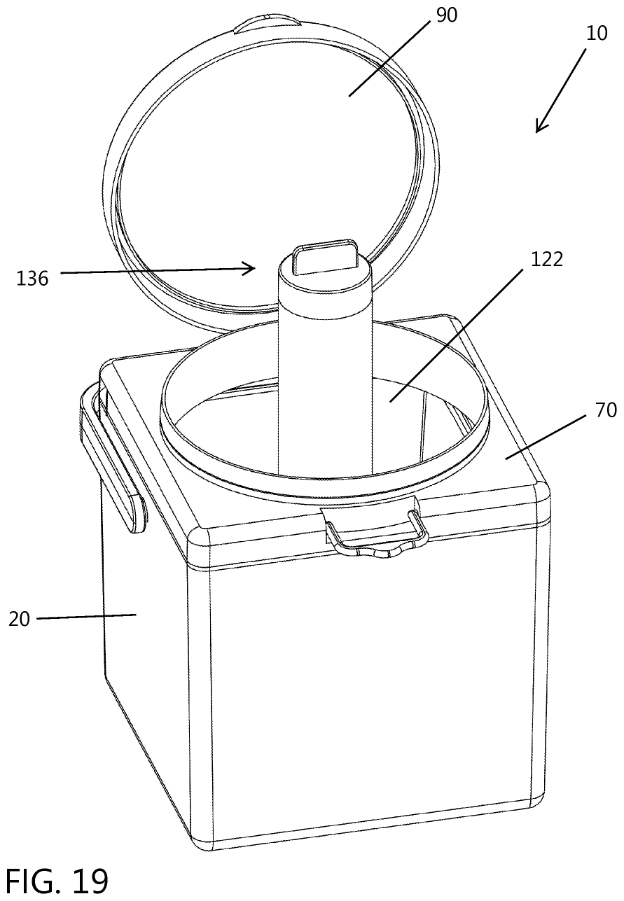

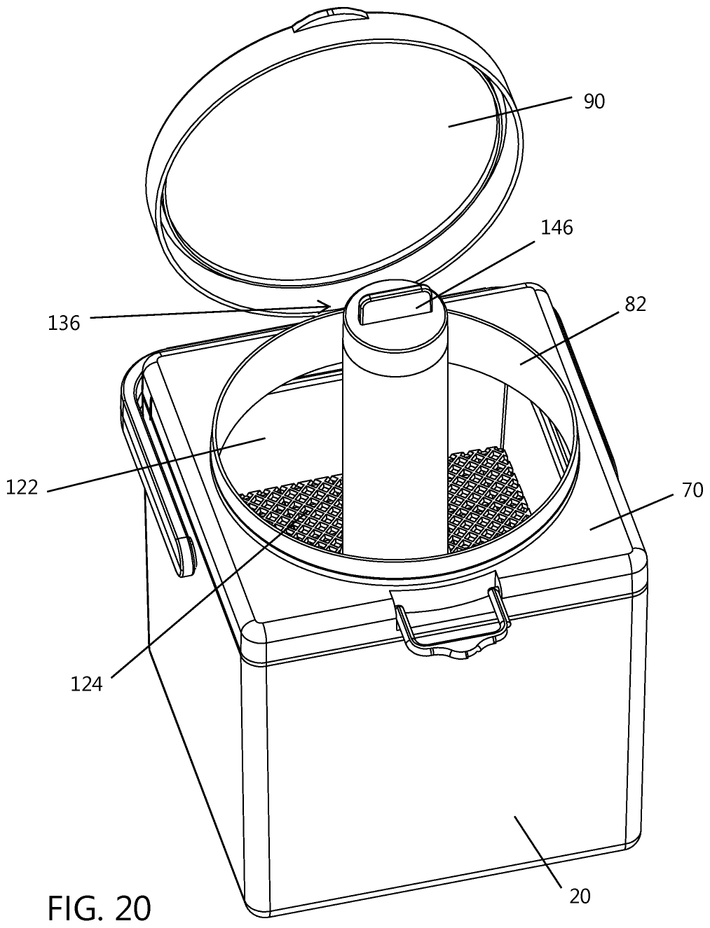

As illustrated in FIGS. 17 through 20, in use the strainer 120 moves within the interior of the receptacle 20 between a stowed position 134 and an elevated position 136. When in the strainer 120 is in the stowed position 134, the cover may rotate down and enclose the central opening 80 of the lid 70. The handle 146 may be used to pull the strainer upward to the elevated position 136. When in the elevated position the upper portion of the sides of the strainer 120 are at approximately the same height as the upper flange 52 of the inner liner 50 of the receptacle 20. Preferably, the level of water within the container is adjusted so that when the strainer is in the elevated position the bait is elevated above the water and when the strainer is in the stowed position the bait is submerged or floating in water. In this manner the strainer 120 may be utilized to separate the bait from the water to allow access to the bait in a more efficient and enjoyable manner for the angler.

These and various other aspects and features of the invention are described with the intent to be illustrative, and not restrictive. This invention has been described herein with detail in order to comply with the patent statutes and to provide those skilled in the art with information needed to apply the novel principles and to construct and use such specialized components as are required. It is to be understood, however, that the invention can be carried out by specifically different constructions, and that various modifications, both as to the construction and operating procedures, can be accomplished without departing from the scope of the invention. Further, in the appended claims, the transitional terms comprising and including are used in the open ended sense in that elements in addition to those enumerated may also be present. Other examples will be apparent to those of skill in the art upon reviewing this document.

What is claimed is:

1. An apparatus for storing live fishing bait, the apparatus comprising:
an insulated receptacle having interior and exterior sides, an open top and an enclosed bottom;
a bait strainer contained within the insulated receptacle, said bait strainer having sides extending upward from a bottom sieve, wherein said bait strainer is sized such that said sides are proximate with corresponding interior sides of the insulated receptacle;
a heat transfer chamber attached to and extending from said bait strainer wherein a free end of said chamber forms a handle for said bait strainer; and
a lid coupled to the open top of said insulated receptacle.

2. The apparatus as recited in claim 1, wherein said lid further includes a hinged cover coupled to an opening formed in said lid.

3. The apparatus as recited in claim 1, wherein said receptacle is comprised of an inner liner and outer shell.

4. The apparatus as recited in claim 2, wherein said insulated receptacle includes retaining hooks that engage an underside of said lid.

5. The apparatus as recited in claim 1, wherein said cooling chamber is attached to said bait strainer proximate a center of said bottom sieve.

6. The apparatus as recited in claim 1, wherein said heat transfer chamber includes a central column and a removable handle forming plug at a top of the central column.

7. The apparatus as recited in claim 1, further including a handle attached to the exterior sides of said insulated receptacle.

8. The apparatus as recited in claim 2, further including a grip member extending from said lid.

9. The apparatus as recited in claim 8, further including a lip extending outward from an outer edge of said cover.

10. An apparatus for storing live fishing bait, the apparatus comprising:
an insulated receptacle having interior and exterior sides, an open top and an enclosed bottom;
a bait strainer contained within the insulated receptacle, said bait strainer having sides extending upward from a bottom sieve, wherein said bait strainer is sized such that said sides are proximate with corresponding interior sides of the insulated receptacle;
a thermal transfer chamber attached to and extending from said bait strainer wherein a free end of said chamber forms a handle of said bait strainer;
a lid coupled to the open top of said insulated receptacle; and
a hinged cover coupled to an opening formed in said lid.

11. The apparatus as recited in claim 10, wherein said receptacle is comprised of an inner liner and outer shell.

12. The apparatus as recited in claim 10, wherein said insulated receptacle includes retaining hooks that engage an underside of said lid.

13. The apparatus as recited in claim 10, wherein said thermal transfer chamber is attached to said bait strainer proximate a center of said bottom sieve.

14. The apparatus as recited in claim 10, wherein said thermal transfer chamber includes a central column and a removable handle forming plug at a top of the central column.

15. The apparatus as recited in claim 10, further including a handle attached to the exterior sides of said insulated receptacle.

16. The apparatus as recited in claim 10, further including a grip member extending from said lid.

17. The apparatus as recited in claim 10, further including a lip extending outward from an outer edge of said cover.

18. An apparatus for storing live fishing bait, the apparatus comprising:
an insulated receptacle having interior and exterior sides, an open top and an enclosed bottom;
a bait strainer contained within the insulated receptacle, said bait strainer having sides extending upward from a bottom sieve, wherein said bait strainer is sized such that said sides are proximate with corresponding interior sides of the insulated receptacle;
a cooling chamber extending from said bait strainer, wherein said cooling chamber includes a central column having a fixed end attached to said bait strainer and a removable handle attached to a free end of the central column, said removable handle forming plug at a top of the cooling chamber;
a lid coupled to the open top of said insulated receptacle; and
a hinged cover coupled to an opening formed in said lid.

19. The apparatus as recited in claim 18, wherein said receptacle is comprised of an inner liner and outer shell.

20. The apparatus as recited in claim 18, wherein said insulated receptacle includes retaining hooks that engage an underside of said lid.
